(19) United States
(12) Patent Application Publication
(10) Pub. No.: US 2006/0244587 A1
(43) Pub. Date: Nov. 2, 2006

(54) Method and apparatus for providing transmission of compressed telemetry data in a tracking system

(75) Inventors: Laymon Scott Humphries, Clinton, MS (US); Huey-Jiun Ngo, Flowood, MS (US)

Correspondence Address: VERIZON;PATENT MANAGEMENT GROUP, 1515 N. COURTHOUSE ROAD, SUITE 500, ARLINGTON, VA, 22201-2909, US

(73) Assignee: MCI, Inc., Ashburn, VA (US)

(21) Appl. No.: 11/116,488

(22) Filed: Apr. 28, 2005

(51) Int. Cl. G08B 1/08

(52) U.S. Cl. 340/539.13

(57) ABSTRACT

An approach is provided for tracking an asset over a wireless network is disclosed. A telemetry device corresponding to the asset generates an encoded message to represent telemetry data in compressed form. The encoded message has a variable length to store a change in the telemetry data. The encoded message is transmitted over the wireless network.

### FIELD OF THE INVENTION

The present invention relates to data communications, and more particularly, to transmitting compressed telemetry data in support of fleet and asset management.

### BACKGROUND OF THE INVENTION

Modern wireless networks, such as paging systems, can readily be configured to offer a variety of telemetry services, notably fleet and asset management. The management of vehicles within a fleet as well as assets involves obtaining information, generally in real-time, about the location and movement of these objects. The fleet manager utilizes this information to maximize use of fleet resources. With the advent of the Global Positioning System (GPS) supported by a constellation of satellites, a vehicle may determine its location with great accuracy and convenience if no obstruction exists between the GPS receiver within the vehicle and the satellites. Additionally, in recognition of the utility of real-time location of vehicles, governmental bodies have begun to impose strict requirements for determining position information of emergency 911 callers. Therefore, with the impetus stemming from competitive and regulatory forces, service providers seek to offer an efficient, cost-effective fleet and asset management service with robust capability by effectively integrating GPS technology with wireless networks as to minimize bandwidth in the exchange of telemetry data.

FIG. 10 shows a diagram of a conventional wireless network in an autonomous GPS environment. As shown, a wireless network 1001 communicates with vehicles 1003 to track the location of these vehicles 1003 within the coverage area of the wireless network 1001. Each of the vehicles 1003 employ a GPS device 1005 that communicates with a constellation of satellites 1007. These satellites 1007 transmit very low power interference and jamming resistant signals received by the GPS receivers 1005. At any point on Earth, a GPS device 1005 is able to receive signals from multiple satellites (e.g., 6 to 10).

Specifically, a GPS device 1005 may determine three-dimensional geolocation from signals obtained from at least four satellites. Measurements from satellite tracking and monitoring stations located around the world are incorporated into orbital models for each satellite to compute precise orbital or clock data. GPS signals are transmitted over two spread spectrum microwave carrier signals that are shared by all of the GPS satellites 1007. The device 1005 must be able to identify the signals from at least four satellites 1007, decode the ephemeris and clock data, determine the pseudo range for each satellite 1007, and compute the position of the receiving antenna. The time required to acquire a position depends on several factors including the number of receiving channels, processing power of the receiving device, and strength of the satellite signals.

The above arrangement, as an autonomous GPS environment, has a number of drawbacks that can hinder its effectiveness as a fleet management system. Because the GPS device 1005 must obtain all of the ephemeris data from the satellite signals, weak signals can be problematic. A building location or a location in any area that does not have clear view of the satellite constellation 1007 can prevent the GPS device 1005 from determining its geolocation. Also, cold start acquisition may consume a few seconds to as much as a few minutes, which is a significant delay for the device's ability to log positional information and evaluate its position against pre-configured alert conditions.

The vehicles 1003 then need to transmit the location information to the wireless network 1001. These transmissions can consume large amounts of bandwidth of the wireless network 1001 if the location information is continually transmitted without attention to the polling scheme and the underlying transmission protocol used to transport such data. Also consideration as to the types and sizes of the transmissions has to be given to efficiently utilize the scarce spectral resource.

Therefore, there is a need for a fleet and asset management system that supports an effective data compression scheme to exchange telemetry data, thereby efficiently utilizing precious resources of the underlying wireless network.

### SUMMARY OF THE INVENTION

These and other needs are addressed by the present invention, in which an approach for providing a compression scheme to encode telemetry data messages for transmission over a wireless network.

According to one aspect of the present invention, a method for tracking an asset over a wireless network is disclosed. The method includes collecting telemetry data associated with the asset. The method also includes generating an encoded message to represent the telemetry data in compressed form, wherein the encoded message has a variable length to store a change in the telemetry data. Further, the method includes transmitting the encoded message over the wireless network.

According to another aspect of the present invention, a method for tracking an asset over a wireless network is disclosed. The method includes transmitting a command to instruct a telemetry device over the wireless network to compress telemetry data associated with the asset. The telemetry device, in response to the command, generates an encoded message to represent the telemetry data in compressed form. The encoded message has a variable length to store a change in the telemetry data. Additionally, the method includes receiving the encoded message over the wireless network.

According to yet another aspect of the present invention, an apparatus for tracking an asset over a wireless network is disclosed. The apparatus includes compression logic configured to generate an encoded message to represent telemetry data associated with the asset in compressed form. The encoded message has a variable length to store a change in the telemetry data. The apparatus also includes a transceiver configured to transmit the encoded message over the wireless network.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a fleet and asset tracking system capable of providing compression of telemetry data, according to an embodiment of the present invention;

FIG. 2 is a diagram of a telemetry device having data compression logic, according to an embodiment of the present invention;

FIG. 3 is a diagram of a compression configuration request message used in the system of FIG. 1 to enable data compression;

FIG. 4 is a diagram of a compression configuration response message used in the system of FIG. 1;

FIG. 5 is a flowchart of a process of encoding data to achieve data compression, according to an embodiment of the present invention;

FIGS. 6A and 6B are diagrams of exemplary message structures supporting an expandable unsigned integer, according to an embodiment of the present invention;

FIGS. 7A and 7B are diagrams of exemplary message structures supporting an expandable signed integer, according to an embodiment of the present invention;

FIG. 8 is a diagram of a Network Operations Center (NOC) in the system of FIG. 1, according to an embodiment of the present invention;

FIG. 9 is a diagram of a computer system that can be used to implement an embodiment of the present invention; and

FIG. 10 is a diagram of a conventional wireless network in an autonomous GPS environment.

### DESCRIPTION OF THE PREFERRED EMBODIMENT

A system, method, and software for selectively compressing telemetry data for transmission over a wireless network are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

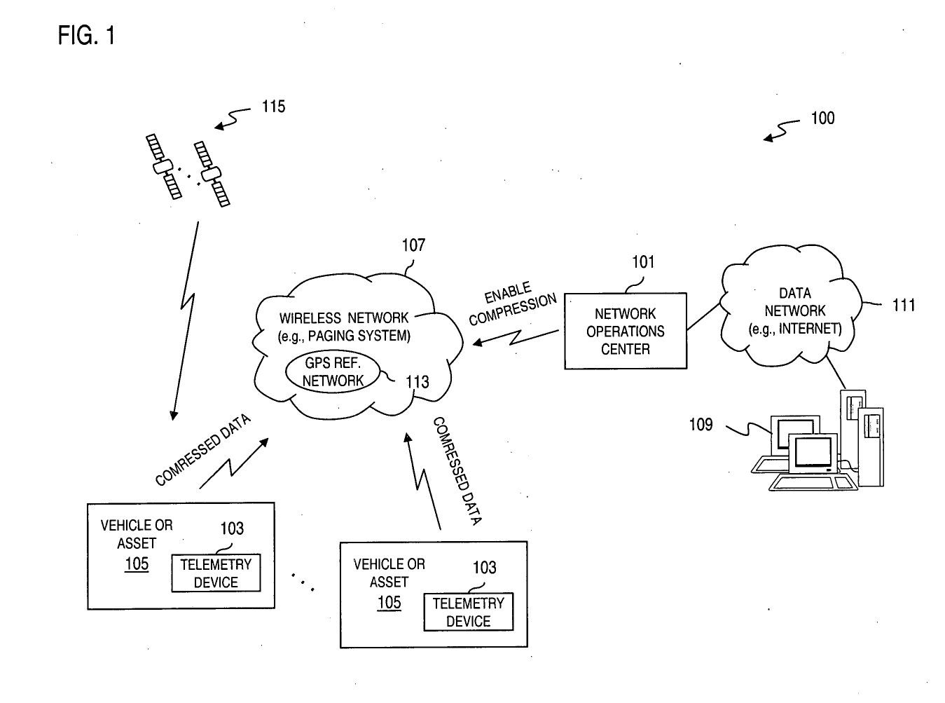

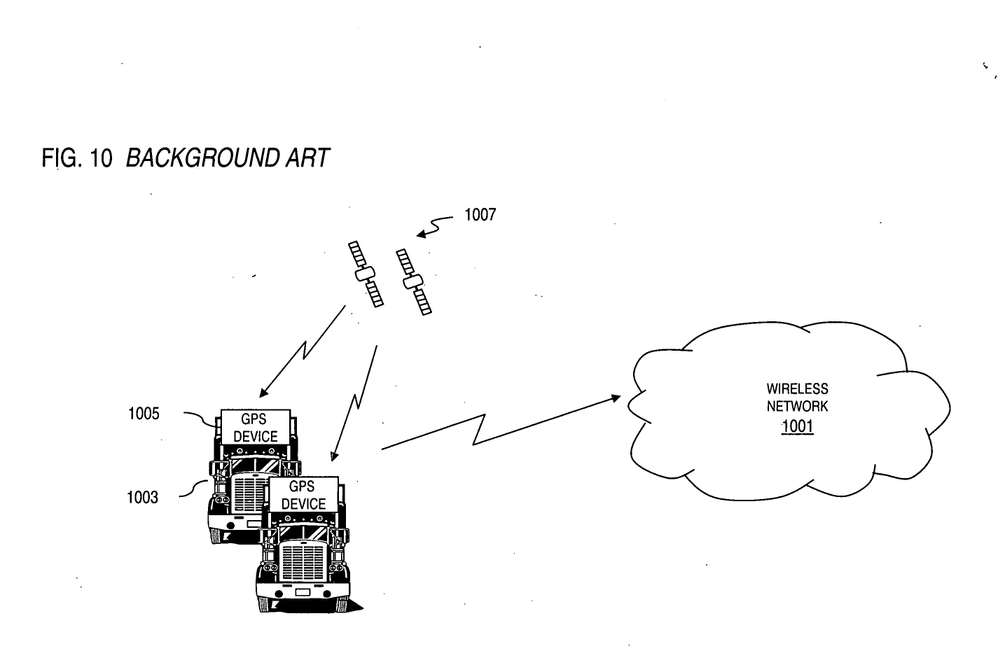

FIG. 1 shows a diagram of a fleet and asset tracking system capable of providing compression of telemetry data, according to an embodiment of the present invention. The system 100, in contrast to the system of FIG. 10, utilizes a combination of autonomous GPS and Assisted GPS (A-GPS); in particular, mobile-centric A-GPS. The system 100 includes a Network Operation Center (NOC) 101 for tracking telemetry devices 103, which, under this scenario, are resident within vehicles 105. It is contemplated that the telemetry device 103 can be affixed to an asset (or any other object). A wireless network 107 supports two-way communication among the telemetry devices 103 and the NOC 101; the wireless network 107, in an exemplary embodiment, is a two-way paging system employing the ReFLEX™ protocol by Motorola for two-way advanced messaging.

In one embodiment of the present invention, the telemetry devices 103 have two modes of operation: autonomous GPS mode, and A-GPS mode. When operating in A-GPS mode, the system 100 can provide for better in building or obstructed view geolocation with in a paging system zone. When out of network coverage, the autonomous GPS may be used to obtain geolocation data that may be stored on the device for later transmission.

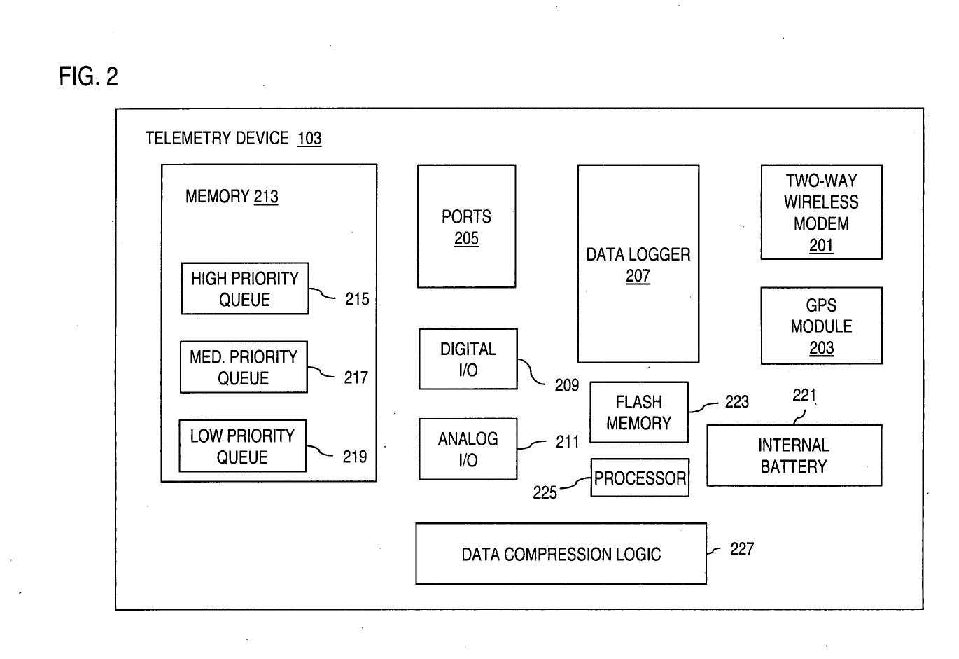

It is recognized that a vast amount of data associated with the asset can be collected and generated by the telemetry devices 103. Such data can consume a significant amount of bandwidth of the wireless network 107. Consequently, the telemetry devices 103 are configured to provide encoding of the data to achieve data compression, whereby the encoded data or messages are of variable length and represent a change (or delta) in the telemetry data relative to the prior telemetry data. These “compressed” messages are transmitted over the wireless network 107 to the NOC 101 and decoded (or “decompressed”) at the NOC 101. In this manner, bandwidth of the wireless network 107 is more efficiently utilized. The compression scheme is further described below with respect to FIG. 2.

According to one embodiment of the present invention, the wireless network 107 provides over the air encrypted messages. For example, the encryption process is more fully described in a commonly assigned co-pending application entitled “Method and Apparatus for Providing Secure Wireless Communication,” (Attorney Docket 09710-1263; Client Docket SKY04004), which is incorporated herein by reference in its entirety.

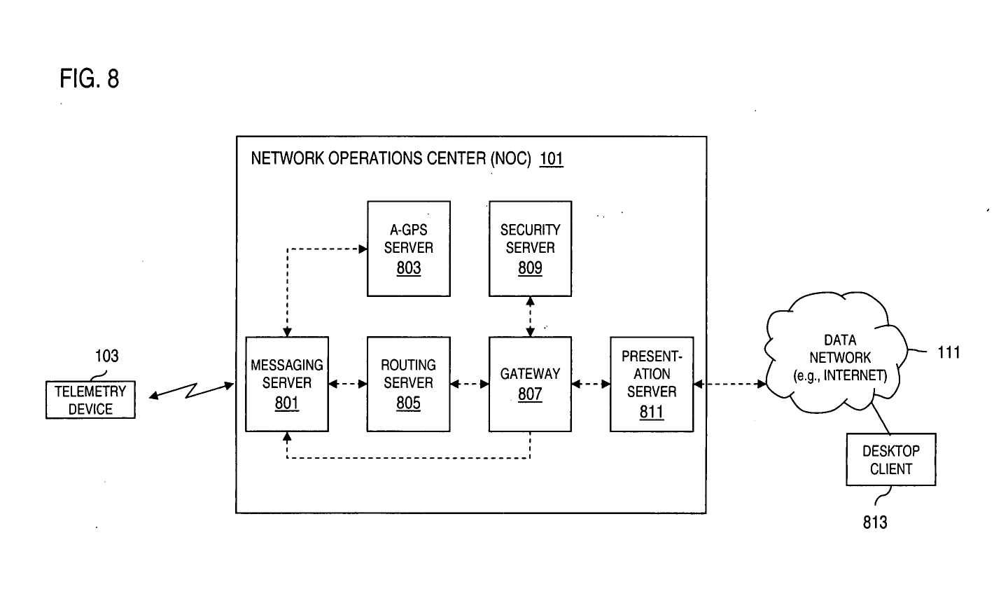

The NOC 101 provides the necessary fleet and asset management functions, such as user account creation and management, access control, and deployment of business rules; these functions are more fully described below with respect to FIG. 8. The NOC 101 also supports remote management capabilities by hosts 109 over a data network 111, such as the global Internet.

To better understand the hybrid A-GPS environment of the system 100, it is instructive to describe the operation of the general operation of a mobile-centric A-GPS system. The telemetry device 103 has GPS hardware and intelligence, whereby the network 107 in conjunction with the NOC 101 employs mechanisms for providing GPS aiding data (or assistance data). The network 107 includes base transmitters and some base receivers containing GPS hardware from which the ephemeris and approximate location can be obtained, constituting a GPS reference network 113.

The assistance data that is transmitted to the devices 103, in an exemplary embodiment, can include ephemeris data differential GPS correct data, timing data and/or other aiding data. Using the aiding (or assistance) data, the telemetry devices 103 performs geolocation calculations, yielding a number of advantages. For example, the telemetry devices 103 can generate real-time speed and route adherence alerts. Additionally, transmission of geolocation data need not be frequent. Transmission of geolocation data is more compact because it is true location rather than pseudo range data. Also, the telemetry devices 103 can more intelligently request assistance data because the devices 103 themselves can determine when the ephemeris data is no longer valid.

The hybrid A-GPS system 100 thus permits fast and precise geolocation when in network coverage of the network 107, while providing immunity from obstructed view of the sky (for communication with GPS satellites 115). Also, when the switch is made to autonomous GPS mode (when outside of the coverage area of the network 107), the devices 103 can still obtain geolocation data. This data can be stored within the device 103 and transmitted to the NOC 101 when the associated vehicle 105 returns to the network coverage area.

As noted earlier, the telemetry devices 103 may be attached to a host entity such as a vehicle or other valuable asset. The device may be used to track, monitor, and control aspects of the host entity. These devices 103 are configurable with respect to the existence and number of digital inputs/outputs (I/O), analog inputs/outputs (I/O), and device port interfaces for connection with peripheral devices. By way of example, the digital inputs can be used to monitor various components of the vehicles 105: ignition status, door lock status, generic switch status, headlight status, and seat occupancy status. The digital outputs can be used to control, for example, the starter, and door locks, and to monitor such parameters as engine temperature, cargo temperature, oil pressure, fuel level, ambient temperature, and battery voltage. The exact configuration of the telemetry devices 103 can be based on cost consideration and/or applications.

The telemetry devices 103, in an exemplary embodiment, employ a wireless protocol to receive commands and transmit data and alerts (e.g., high speed alert) over the radio network 107. The telemetry devices 103 can queue alerts, message responses, and scheduled data, whereby if the devices 103 are unable to send the messages, the messages are queued and sent when the device 103 returns to wireless network coverage. Prioritized queues are used and include, for example, queues for high, normal, and low priority messages. In the exemplary implementation, critical device status changes are given highest priority, while other alerts and responses are given normal priority. Scheduled data messages are given the lowest priority. The queues are configured, as first in yields first out, wherein new messages are dropped when its corresponding queue is full. This arrangement advantageously allows for the status of the device 103 at the time of transmission failure to be known even when the data stored in the data log at time of the transmission has been overwritten.

The telemetry devices 103 can also respond to status (e.g., of position, speed, digital I/O port status, analog input channel status, peripheral status or other device status) queries transmitted by the NOC 101. The status query may request either current status or status within a time and date range. The device 103 responds to the query with either the current status or all status within the date and time range that is currently stored in the device's data log.

As regards data logging, the devices 103 support use of one or more schedules for the data acquisition. The data logging involves storing of the data locally on the device 103. This data, which can include position, speed, distance traveled (“tripmeter”), digital I/O port status, analog input channel status, peripheral status or other device status is not automatically transmitted over the air. Instead, the data is stored for a finite period of time and made available for use by scheduled data acquisitions, data acquisitions on demand, and data acquisitions associated with alerts. The data log is circular in that when the last available memory for the data logger has been written, the data logger begins recording new data at the first location of memory available for the data logger.

With scheduled acquisitions of the data collected by the data logger, the data within the data log is transmitted by the device 103 according to a configurable schedule at the configured transmission rate. Multiple schedules may be configured on the device 103. Schedules are configured to obtain data at a regular interval based upon calendar time and date. Schedules may be configured such that they are enabled and disabled based upon status of a digital input. For example, an ignition status input may be used to turn a schedule on when the engine is on and turn the schedule off when the engine is off.

As mentioned previously, the telemetry devices 103 can be configured to monitor a variety of information relating to the vehicle or asset through the digital I/O and analog I/O. For instance, alerts can be used to indicate status change of the digital inputs. Each Digital Input Status Change Alert can be enabled and disabled through configuration. The alert may be configured to transmit other device status recorded at the time of the alert such as position, speed, tripmeter value, status of other digital I/O ports, analog input status, peripheral status, or other device status. As regards the digital output, the status of each available digital output can be changed or read.

Similarly, the statuses of analog inputs of the devices 103 are monitored for change. In an exemplary embodiment, multiple threshold levels (e.g., high and low) can be set, whereby alerts are generated (e.g., Low Range Entry alert, Low Range Exit, High Range Entry, and High Range Exit). That is, if the value of the Analog Input falls below the Low Threshold, a Low Range Entry Alert is generated. If the value of the Analog Input rises above the Low Threshold plus a Hysteresis is value, a Low Range Exit Alert is generated. In similar fashion, if the value of the Analog Input rises above the High Threshold, a High Range Entry Alert is output from the device 103. Also, if the value of the Analog Input falls below the High Threshold minus a Hysteresis value, a High Range Exit Alert is generated. The alert may be configured to transmit other device status recorded at the time of the alert such as position, speed, status of other digital I/O ports, analog input status, peripheral status, or other device status.

By way of example, the devices 103 can be used to monitor excessive speed via a High Speed Alert Control, whereby a High Speed Threshold can be set by a fleet manager. In addition, a duration parameter (i.e., High Speed Duration) can be utilized to specify the time at which the High Speed Threshold must be exceeded before an alert is generated. Further, a configurable High Speed Hysteresis parameter is set as the delta change below the High Speed Threshold used to determine when the High Speed Threshold has no longer been exceeded. The alert may be configured to transmit other device status recorded at the time of the alert such as position, speed, status of other digital I/O ports, analog input status, peripheral status, or other device status.

The system 100 also permits users via the hosts 109 to specify and configure areas of interest within the coverage area of the network 101 such that alerts can be generated when a device 103 enters or exits the configured areas. The alert may be configured to transmit other device status recorded at the time of the alert such as position, speed, status of other digital I/O ports, analog input status, peripheral status, or other device status.

The data collected and transmitted by the telemetry devices 103 are processed by the NOC 101, the components of which are described in FIG. 8.

FIG. 2 shows a diagram of a telemetry device having data compression logic, according to an embodiment of the present invention. The telemetry device 103, which can be deployed within a vehicle (as shown in FIG. 1 or coupled to any asset), operates within the wireless network 107. For illustrative purposes, the components of the telemetry device 103 are described in the context of a narrowband network, such as a paging system; however, it is contemplated that the components for communications can be tailored to the specific wireless network.

In this exemplary embodiment, the telemetry device 103 includes a two-way wireless modem 201 for receiving and transmitting signals over the wireless network 107 according to the communication protocols supported by the wireless network 107, such as the Motorola ReFLEX™ protocol for two-way paging. By way of example, a Karli ReFLEX™ module by Advantra International can be used for the modem 201. The two-way wireless modem 201 couples to a two-way wireless antenna (not shown) that can be placed local to the device 103 or remote from the device 103 (e.g., 12 or more feet) to enhance flexibility in installation.

The telemetry device 103 also contains a GPS module 203 that is capable of operating in the multiple GPS modes: autonomous GPS mode, and mobile-based A-GPS mode. The GPS module 203 can employ, for example, a GPS receiver manufactured by FastraX-iTrax02/4. In autonomous mode, GPS data may be acquired with no assistance data provided by the wireless network 107. The GPS module 203 operates in the A-GPS mode when the device 103 is in wireless network coverage, in which assistance data is supplied and can include ephemeris data and data to obtain location in obstructed view locations (in building, wooded areas, etc.). Further, the assistance can include differential GPS (DGPS) to enhance location accuracy under some conditions. The GPS module 203 couples to a GPS antenna (not shown) that can be placed local to the device 103 or remote from the device 103 (e.g., 12 or more feet) to enhance flexibility in installation.

Attachment of peripheral modules to the telemetry device 103 are supported by one or more peripheral ports 205. The ports 205, for example, can be used to connect to intelligent peripherals that operate according to business rules and logic. These business rules and logic can be housed in a vehicle harness (not shown), which include an On-Board Diagnostic (OBDII) interface and intelligence. Under this arrangement, a user (e.g., fleet manager) can query any parameter available through the OBDII interface. For example, data obtained for each tracking record can include any combination of the following items: RPM (Revolutions Per Minute), oil pressure, coolant temperature, etc. Such data recorded by the telemetry device 103 is stored in memory 213. The acquisition period for the data is configurable, as well as the transmission interval to the NOC 101. Furthermore, the monitoring and subsequent data exchange can be governed by a configurable schedule, which can specify such parameters as start date, start time, end time, recurrence (e.g., daily, weekly, monthly, etc.), and duration.

Data is logged by a data logger 207, made available for use by scheduled data acquisitions, data acquisitions on demand, and data acquisitions associated with alerts. As mentioned, the telemetry device 103 also can be configured to include digital I/O 209 and analog I/O 211 for monitoring and control of the vehicle or asset. The data logger 207 also collects data associated with these I/O ports 209, 211.

The telemetry device 103 also includes a processor 225 that may handle arithmetic computations, and may support operating system and application processing. The processor 225, while shown as a single block, may be configured as multiple processors, any of which may support multipurpose processing, or which may support a single function.

The memory 213 of the telemetry device 103 can be organized to include multiple queues for prioritizing the messages to be processed by the device 103. In an exemplary embodiment, the memory 213 includes a High Priority queue 215, a Medium Priority queue 217, and Low Priority queue 219. The memory 213, while shown as a single block, may be configured as multiple memory devices, any of which may support static or dynamic storage, and may include code for operating system functionality, microcode, or application code.

Data recorded by the telemetry device 103 may additionally be stored in a storage medium other than the prioritized queues 215, 217, and 219, such as in a flash memory 223. A log (not shown) of information may be kept so that the information may be transmitted according to a schedule, as discussed above, or, e.g., upon receipt of a request to send all data that has been collected. Storage devices have only a finite amount of space for storage of information, and thus the information for only a finite number of messages may be stored in either the prioritized queues 215, 217, 219 or the flash memory 223.

To improve availability of the telemetry device 103, an internal battery 221 is optionally included. With the internal battery, the telemetry device 103 can continue to monitor and transmit alerts and status information to the NOC 101 even if the electrical system of a vehicle is inoperable. Additionally, the internal battery 221 can be used by the device 103 to gracefully report power status wirelessly and shut down gracefully when the energy level of the internal battery is becoming to low to sustain operation of the device.

As shown, the telemetry device 103 includes data compression logic 227 for encoding telemetry data corresponding to the asset that is being tracked. In general, the encoding or compression scheme provides for delta compression with respect to previous data value or a reference value. Exemplary telemetry data include positional data, such as the GPS information, as well as any data stemming from the digital I/O 209 and the analog I/O 211. In accordance with one embodiment of the present invention, the data compression scheme utilized by the data compression logic 227 accounts for the following scenarios: Delta compression with respect to the previous position, Delta compression with respect to a reference point, encoding a non-movement position, and encoding position unavailable. For instance, when multiple points are encoded, after the first position is encoded, only the difference is required for each subsequent point. The difference is encoded using a variable size integer to minimize data size requirements. Single points and first points in a sequence may be encoded as the difference between the point and a previously configured reference point.

Furthermore, if no movement is detected, a minimized encoding approach is used to indicate the device has not moved. Likewise, a minimized encoding of invalid data is also provided.

Other types of compressed telemetry data (e.g., digital I/O, analog inputs, tripmeter) are encoded as the difference between the current status and previous status. The compressed data is transmitted to the NOC 101 over the wireless network 107.

According to one embodiment of the present invention, the data compression logic 227 can be activated (enabled) or deactivated (disabled) by appropriate commands from the NOC 101. This capability advantageously provides flexibility in implementation of the telemetry devices 103. The functions of the NOC 101, which interacts with the telemetry devices 103 to exchange information for supporting fleet and asset management, are detailed with respect to FIG. 8.

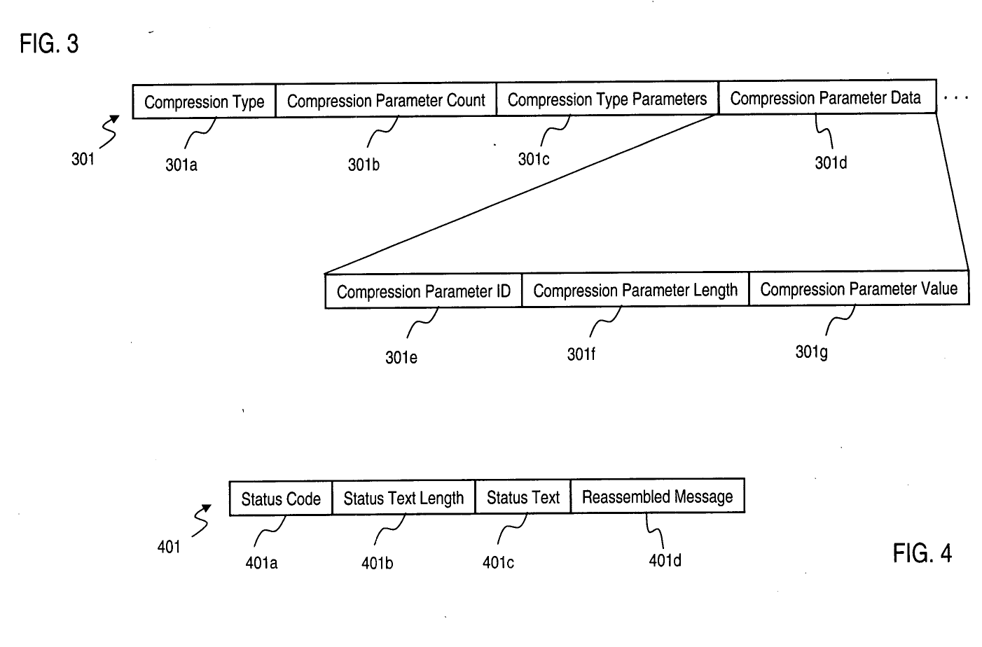

FIG. 3 is a diagram of a compression configuration request message used in the system of FIG. 1 to enable data compression. To activate the data compression feature of the telemetry devices 103, the NOC 101 sends a Compression Configuration Request message 301 to the particular device. In an exemplary embodiment, the message 301 includes a Compression Type field 301a, a Compression Parameter Count field 301b, a Compression Type Parameters field 301c, and one or more Compression Parameter Data fields 301d. These fields 301a, 301b and 301c are defined below in Table 1.

TABLE 1

| Field | Definition |
|---|---|
| Compression Type | Determines the type of compression scheme to be |
| | used; e.g., no compression or data is compressed by |
| | encoding changes in location (delta location) with |
| | respect to a reference point or previous position. |
| Compression | Number of parameters following compression type. |
| Parameter Count | |
| Compression Type | List of one or more parameters specific to the |
| Parameters | Compression Type identified. |

The Compression Parameter Data field 301d further includes a Compression Parameter Identification (ID) field 301e, a Compression Parameter Length field 301f, and a Compression Parameter Value field 301g, as enumerated in Table 2.

TABLE 2

| Field | Definition |
|---|---|
| Compression | Identifies the compression parameter to be set |
| Parameter ID | |
| Compression | Length of the following Compression Parameter |
| Parameter Length | value |
| Compression | Compression Parameter Value Data |
| Parameter Value | |

When delta compression is enabled at the telemetry device 103, the following data compression parameters, in an exemplary embodiment, are specified: a “UseReferencePoint” parameter to indicate whether reference point delta compression should be used, a Reference Latitude parameter specifying the Latitude of the GPS antenna, a Reference Longitude indicating the Longitude of the GPS antenna, Reference Altitude parameter to specifying Altitude of the GPS antenna, and a Reference ID parameter indicating the ID associated with the reference point.

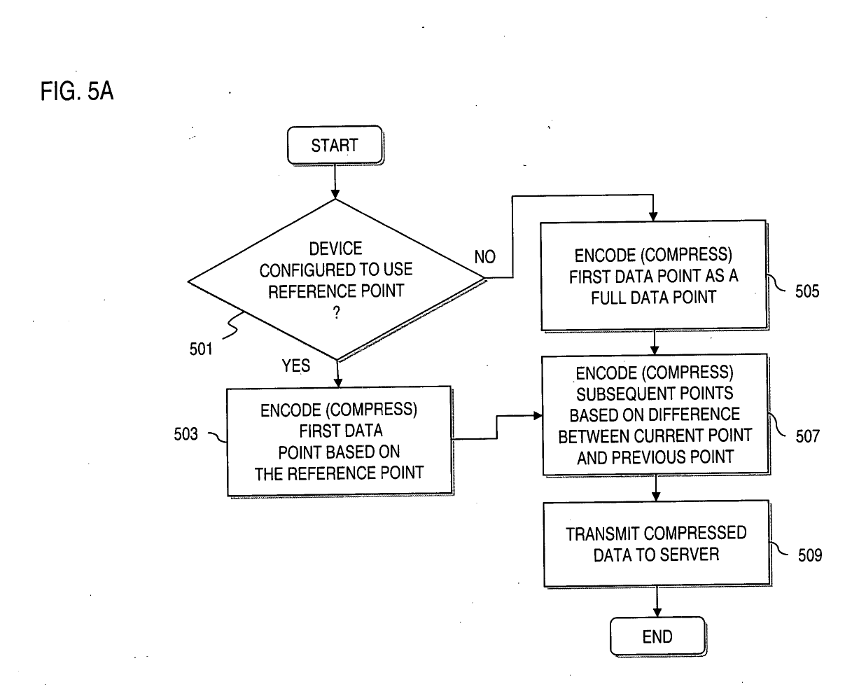

FIG. 4 is a diagram of a compression configuration response message used in the system of FIG. 1. Upon receiving the Compression Configuration Request message 301 for enabling the compression scheme, the telemetry device 103 in turn generates a Compression Configuration Response message 401 pertaining to the status of the request. In an exemplary embodiment, the Response message 401 includes the following fields: a Status Code field, a Status Text Length field 401b, a Status Text field 401c, and a Reassembled Message field 401d. These fields 401a-401d are defined below in Table 3.

TABLE 3

| Field | Definition |
|---|---|
| Status Code | Indicates Status of the Request |
| Status Text Length | Length of Text Message |
| Status Text | Textual description of the status code; size depends |
| | upon the Status Text Length. |
| Reassembled | The device is responsible for re-assembling the |
| Message | message delivered to it and relaying it back to the |
| | NOC 101. |

The Request message 301 and Response message 401 are exchanged to support the data compression capability of the telemetry device 103, as next explained.

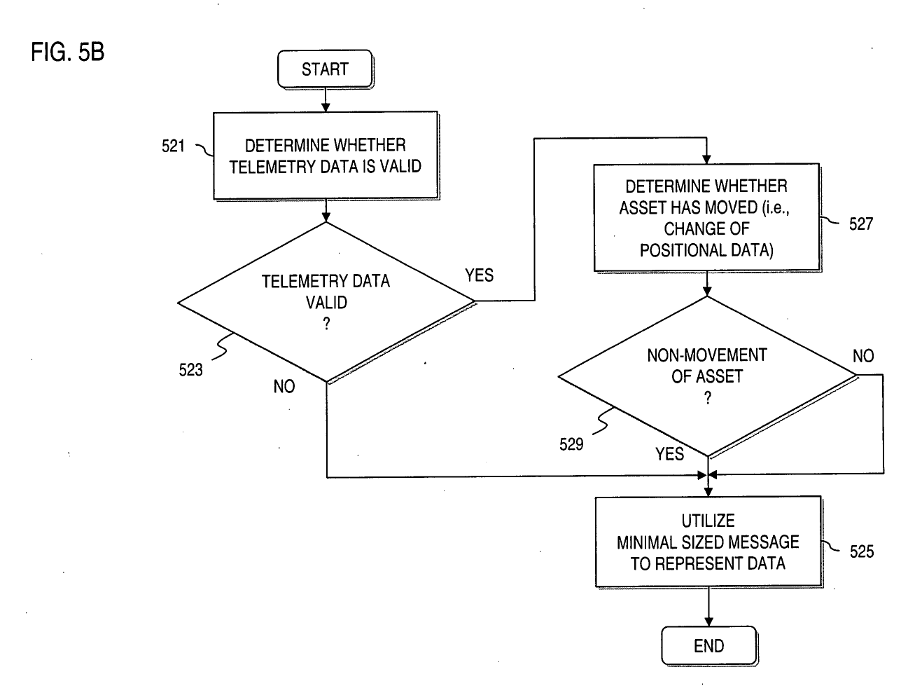

FIGS. 5A and 5B are flowcharts of a process of encoding data to achieve data compression, according to an embodiment of the present invention. The data compression logic 227 of the telemetry device 103 aims to reduce the size of the messages that contain telemetry data. Specifically, in one embodiment of the present invention, delta compression is utilized, whereby only the changes in the telemetry data are sent.

As noted, the data compression scheme can be based on use of a reference point as a baseline. In step 501, the device 103 determines whether the command specifies use of a reference point. The Compression Configuration Request message 301 enables and defines the reference point. If a reference point is to be used, the compression scheme encodes the first data point by determining the difference between this first data point and the reference point, as in step 503.

In certain embodiments, the telemetry data comprises a set of data, such as GPS data point, acquisition time and date, I/O data, and GPS sample. Under this scenario, the difference between the first point and the reference point is computed. However, the time and date is encoded as a Full Acquisition Time and Date, and the I/O data as Full I/O Sample. The GPS data is encoded as Delta GPS Sample. For each additional “good” (or valid) GPS data point, the difference between the current point and previous point. Additionally, the time and date, the I/O data, and the GPS data are delta encoded, respectively, as Delta Acquisition Time and Date, Delta I/O Sample, and Delta GPS Sample.

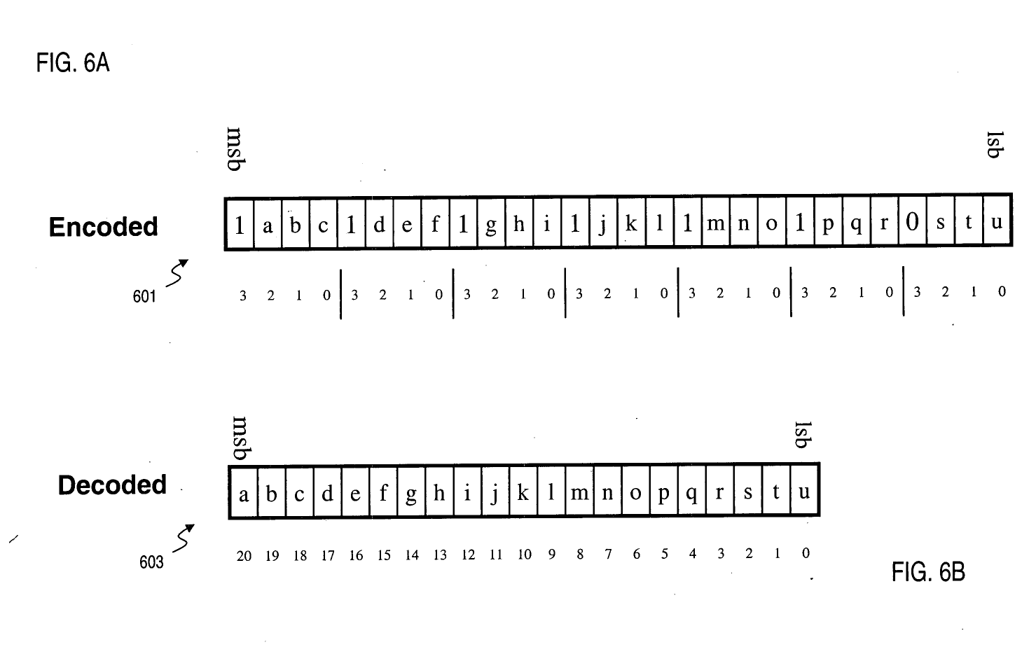

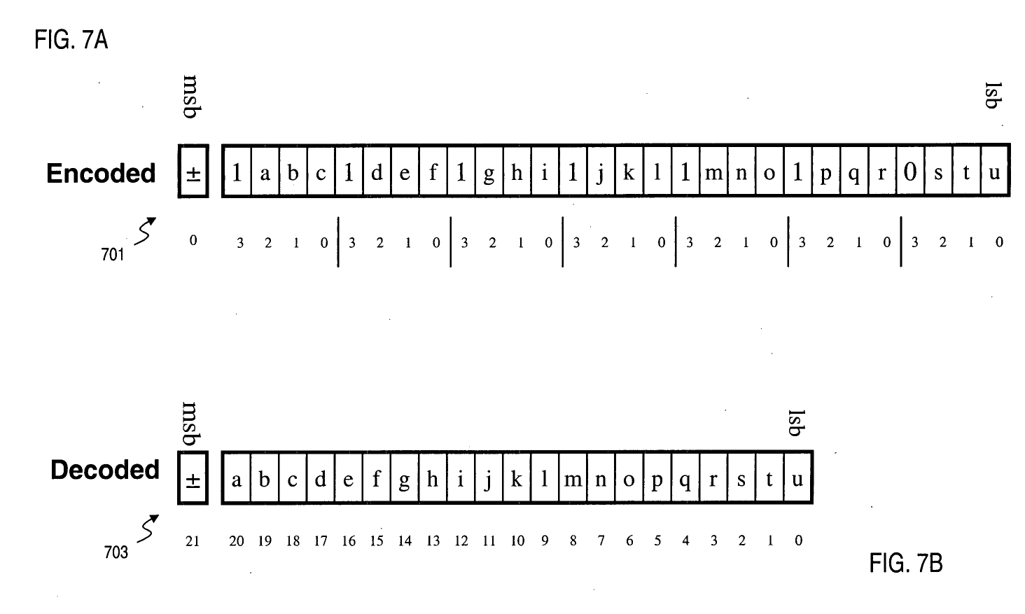

However, if no reference point is to be used, the data compression logic 227 encodes the first data point as a “full” (or uncompressed) data point (step 505). For instance, in the case of GPS information, the size of the Latitude, Longitude, and Altitude on single point messages is reduced by sending the difference from the reference point. The data compression logic 227 can encode the difference data with a compact data format (e.g., 4-bit expandable integer), as described in FIGS. 6 and 7. Continuing with the example of telemetry data set (e.g., GPS data point, acquisition time and date, I/O data, and GPS sample), with no reference point, all the data are unencoded or fully specified: Full data point, Full Acquisition Time and Date, Full I/O Sample, and Full GPS Sample. For the subsequent good GPS data points, as in the case with a Reference point, the differences (“deltas”) are computed.

In step 507, the subsequent data points are encoded based on the difference between the current point and the previous point. The difference in the telemetry data is then transmitted, as in step 509.

According to one embodiment of the present invention, as an enhancement to the data compression scheme, the telemetry data can be pre-processed, such that the encoding process can be avoided and the “compressed” telemetry data can simply be mapped to predetermined messages of minimal sizes (i.e., using minimal number of bits). As seen in FIG. 5B, the pre-processing can involve determining whether the telemetry data is valid, and if the data is invalid, a minimal sized message can be used to represent the data, per steps 521, 523 and 525.

Assuming that a reference point is employed, if the first point is an invalid GPS point, the following encoding process occurs. The first invalid data point is encoded, whereby the time and date is encoded as Full Acquisition Time and Date and the I/O data as Full I/O Sample. The GPS data, however, is encoded as an Invalid GPS Sample. The first good GPS data point is encoded by calculating the difference between the valid GPS point and the reference point. The time and date is encoded as Delta Acquisition Time and Date. Also, the I/O data is encoded as Delta I/O Sample. The GPS data is encoded as Delta GPS Sample. For each additional good GPS data point, the differences are computed. That is, the difference between the current point and previous point is calculated, the time and date is encoded as Delta Acquisition Time and Date, the I/O data is encoded as Delta I/O Sample, and the GPS data is encoded as Delta GPS Sample.

If the first several points are invalid GPS points and assuming that a reference point is specified, the following occurs. The first invalid data point is encoded by encoding the time and date as Full Acquisition Time and Date, the I/O data as Full I/O Sample, and the GPS data as Invalid GPS Sample. For each additional invalid data point, the time and date are encoded as Delta Acquisition Time and Date, the I/O data as Delta I/O Sample, and the GPS data as Invalid GPS Sample. The first good GPS data point can be encoded by calculating the difference between the valid GPS point and the reference point, wherein the delta messages are used for the time and date, the I/O data, and the GPS data. For subsequent good GPS data points, the differences are determined.

If after having encoded a few points, an invalid GPS point interrupts the sequence of Good GPS points, the data compression logic 227 takes the following actions. For each additional good GPS data point, the difference between the current point and previous point are computed, and the delta values are determined for the time and date, the I/O data, and the GPS data. For each additional invalid data point, the time and date are encoded as Delta Acquisition Time and Date, the I/O data as Delta I/O Sample, and the GPS data as Invalid GPS Sample.

In addition, the data compression logic 227 can also determine whether the telemetry data, in the case of positional information, corresponds to non-movement of the asset, as in steps 527 and 529. Such a scenario can likewise be conveyed using a predetermined message of minimal size, effectively providing “compression” of the data. In other words, a filtering technique can provide the criteria for determining whether movement has occurred from one point to the next. When these criteria are applied, some points may be deemed as “No Change GPS Points” or non-movement. For each No Change data point, the data compression logic 227 encodes the time and date as Delta Acquisition Time and Date, the I/O data as Delta I/O Sample, and the GPS data as a No Change GPS Sample (represented with minimal bits).

As mentioned, the difference in telemetry data can be represented in a variable length message. Namely, expandable unsigned or signed integers are employed.

FIGS. 6A and 6B are diagrams of exemplary message structures supporting an expandable unsigned integer, according to an embodiment of the present invention. Data size can be reduced using expandable integers that grow as needed to encode integer data, which corresponds to the difference values. As seen in FIG. 6A, an encoded stream 601 has the Most Significant Bit (MSB) of each segment of bits (e.g., nibble or word) to indicate whether there are any subsequent nibbles. The MSB of each octet is dropped when concatenating the integer data to yield the decoded stream 603, as seen in FIG. 6B. Using this technique to the encode the integer data, Table 4 shows how exemplary integer values, 24, 1136 and 79, are represented in the corresponding encoded binary values.

TABLE 4

| Integer | Encoded Binary Value |
|---|---|
| 24 | 1011B 0000B |
| 1136 | 1010B 1001B 1110B 0000B |
| 79 | 1001B 1001B 0111B |

FIGS. 7A and 7B are diagrams of exemplary message structures supporting an expandable signed integer, according to an embodiment of the present invention. The encoded stream 701, unlike that of the stream 601 of FIG. 6A, includes a sign bit at the Most Significant Bit (MSB). Similarly, the decoded stream 703 includes a sign bit at the MSB position. Table 5 shows the encoded binary values of the examples, 24, 1136 and −79.

TABLE 5

| Integer | Encoded Binary Value |
|---|---|
| 24 | 0B 1011B 0000B |
| 1136 | 0B 1010B 1001B 1110B 0000B |
| −79 | 1B 1001B 1001B 0111B |

The above processes and data structure advantageously provide efficient use of capacity within the wireless network 107, as fewer bits are used to transmit telemetry data.

FIG. 8 shows a diagram of a Network Operations Center (NOC) in the system of FIG. 1, according to an embodiment of the present invention. The NOC 101 utilizes, in this exemplary embodiment, a client-server architecture to support the telemetry devices 103. Specifically, the NOC 101 houses a messaging server 801 for sending and receiving messages to the devices 103 over the air, for storing the messages, and routing these messages to their destination. If the telemetry data received from the telemetry device 103 are compressed (per the processes of FIGS. 5A and 5B), the messaging server 801 can appropriately decode the received data.

The NOC 101 provides connectivity via a local area network (LAN) (not shown) for the messaging server 801 with an A-GPS server 803, a routing server 805, and a gateway 807. The gateway 807 communicates a with a security server 809 to support encryption and decryption of the messages. A presentation server 811 resides within the NOC 101 to interface with the data network 111 (e.g., the global Internet), such that the host 109 can access the services of the fleet and asset management system. The host 109 under this scenario is loaded with a desktop client 813.

Although a single server is shown for the presentation server 811, in the alternative, the server 811 can functionally be implemented as three separate servers: a database server, a middleware server, and a web server. The database server is responsible for data storing, data updating, and data retrieval as well as providing a set of interfaces to achieve these functions. The web server is responsible for serving maps, presenting user interfaces to manage and control user administration, device configuration, and etc. The middleware server can be deployed between the database server and the web server, and has the following responsibilities: converting the web server's data retrieval requests to database server Application Programming Interfaces (APIs) and then sending to database server, receiving the responses from the database server and then sending back to web server, receiving data from gateway 807 and then sending requests to the database to store/update data records. Because of the modularity in this design, these three components can reside on the same machine, as shown in FIG. 8, or reside in multiple platforms.

Messages from the telemetry devices 103 are forwarded by the messaging server 801 to either the A-GPS server 803 or the routing server 805. If the message is an assist request, this message is sent to the A-GPS server 803. In response to the GPS assist request, the A-GPS server 803 determines GPS assistance data for transmission to the requesting telemetry device 103.

The A-GPS server 803 obtains ephemeris data from the GPS reference network 113, and determines satellite configuration for each of the geographic zones comprising the wireless network. The A-GPS server 803 also determines the assistance data for each geographic zone. The NOC 101 then periodically broadcasts the assistance data to each geographic zone. In addition, the A-GPS server 803 supplies GPS assistance data to any telemetry device 103 that requests the GPS assistance data. When supporting this request, the NOC 101 determines approximate location of the requesting device 103 (based upon base receivers that received the request, using a type of triangulation. Subsequently, a GPS Assistance message is generated by the A-GPS server 803 to send to the telemetry device 103 based upon its approximate location. The messaging server 801 sends the GPS Assistance message to the particular telemetry device 103.

Thus, the A-GPS server 803 delivers GPS assistance data through two mechanisms by periodically broadcasting GPS assistance data to all devices 103 in each of the geographic zones covered by the wireless network 107, or by responding to specific requests by the telemetry devices 103 for GPS assistance data.

The routing server 805 has responsibility for routing of the messages from the telemetry devices 103, and managing such messages from the devices 103 to their server destinations. Each device 103 can be configured to have messages directed to one or more destination servers. The routing server 805, upon receiving message from a telemetry device 103, determines a destination address that has been configured for the device 103 and modifies the destination address accordingly. The message is then forwarded to the configured destination. By default, the messages are directed to the gateway 807.

The gateway 807 interfaces with the presentation server 811 to permit the desktop client 813 access to the fleet and asset management system. The gateway 807 provides translation of wireline messages and commands from the presentation server 811 to the wireless protocol for communication with the telemetry devices 103. For example, the gateway 807 supports an eXtensible Markup Language (XML) interface, such that XML commands submitted to the gateway 807 over wireline are converted to the wireless protocol commands and sent over the paging network 107 to the devices 103. In turn, the wireless protocol messages received from the devices 103 are converted to wireline XML messages. The gateway 807 provides translation of wireline messages and commands from the host 109 to the wireless protocol for communication with the telemetry devices 103. In turn, the wireless protocol messages received from the devices 103 are converted to wireline XML messages and sent to host 109.

The presentation server 811 provides the following functions: fleet and asset tracking, and general purpose I/O monitoring and control. The server 811 also maintains a database (not shown) for user accounts and other related data (e.g., configuration data, user management information, device management, and data acquired from the devices 103). The presentation server 811, as mentioned, also generates the maps corresponding to where the devices 103 are tracked and the mapping preferences configured. Using the desktop client 813, a user can even issue requests to command a particular device 103, such as enabling/disabling the data compression capability or simply requesting location of the device 103.

With the presentation server 811 as a front end, a user via the desktop client 813 can configure the telemetry devices 103 via web interfaces. In an exemplary embodiment, the server 811 is a World Wide Web (“web”) application server to support a web browser based front-end for the desktop clients 109. The web application server (not shown) can be deployed to support such web interfaces as a set of Java Server Pages (JSP) and Java Applet to interact with the user on the desktop client 813. On the backend, based on data collected by JSP and Java Applet, the web server can generate the proper XML commands that are compliant with Application Programming Interface (API) of the presentation server 811. Consequently, the collected records can be stored in the database of the presentation server 811. The database also stores the properties of the telemetry devices 103, such as the alerts and thresholds earlier described.

The desktop client 813 interfaces to the system 100 through the presentation server 811. From the desktop client 813, the user logs in to the system 100. The presentation server 811 can also perform authentication as well as administration tasks such as adding new users or devices 103. The user can also configure business rules executed by the presentation server 811, wherein the business rules logic uses this user supplied configuration to configure the devices 103, acquire, and process data from the devices 103.

Additionally, the presentation server 811 provides a reporting capability based on the stored information in the database. The presentation server 811 can support standard reports or customize reports to the user via the desktop client 813.

Instead of using a desktop client 813, the user, if associated with a large organization, can utilize an enterprise server to obtain all of the user functionality through the gateway 807 using the API of the fleet and asset management system 100. Accordingly, the enterprise server would possess the functional capabilities of the presentation server 811, but would be managed by the customer (or user) at the customer's premise.

As noted, a wireless protocol supports communications between the NOC 101 and the telemetry devices 103. In an exemplary embodiment, the messaging is performed according the FLEXsuite Uniform Addressing & Routing (UAR) protocol (developed by Motorola). The wireless protocol message, which can be encapsulated with an UAR message, is unencrypted.

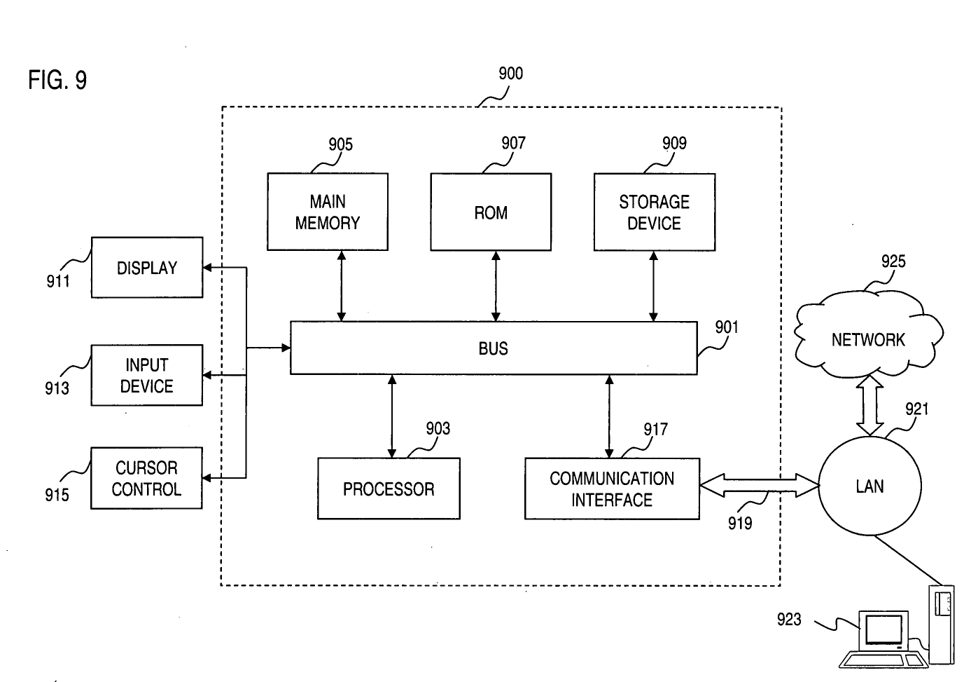

FIG. 9 illustrates a computer system 900 upon which an embodiment according to the present invention can be implemented. For example, the client and server processes for supporting fleet and asset management can be implemented using the computer system 900. The computer system 900 includes a bus 901 or other communication mechanism for communicating information and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to one embodiment of the invention, the processes of the servers and clients in the system 90 of FIG. 1 are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the present invention. Thus, embodiments of the present invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the present invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 905 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

The following patent applications are incorporated in their entireties: co-pending U.S. patent application (Attorney Docket No. 09710-1208) filed Jan. 16, 2004, entitled “Method and System for Tracking Mobile Telemetry Devices”; co-pending U.S. patent application (Attorney Docket No. 09710-1209) filed Jan. 16, 2004, entitled “Method and System for Remotely Configuring Mobile Telemetry Devices”; co-pending U.S. patent application (Attorney Docket No. 09710-1210) filed Jan. 16, 2004, entitled “Method and System for Mobile Telemetry Device Prioritized Messaging”; co-pending U.S. patent application (Attorney Docket No. 09710-1211) filed Jan. 16, 2004, entitled “Method and System for Interfacing with Mobile Telemetry Devices”; co-pending U.S. patent application (Attorney Docket No. 09710-1212) filed Jan. 16, 2004, entitled “Method and System for Transmitting Assistance Location Data for Fleet and Asset Management”; co-pending U.S. patent application (Attorney Docket No. SKY-03-003) filed Jan. 16, 2004, entitled “Method and System for Tracked Device Location and Route Adherence via Geofencing”; and co-pending U.S. patent application (Attorney Docket No. SKY-03-009) filed Jan. 16, 2004, entitled “Method and System for Secured Wireless Data Transmission to and from a Remote Device.”

While the present invention has been described in connection with a number of embodiments and implementations, the present invention is not so limited but covers various obvious modifications and equivalent arrangements, which fall within the purview of the appended claims.

What is claimed is:

1. A method for tracking an asset over a wireless network, the method comprising:
collecting telemetry data associated with the asset;
generating an encoded message to represent the telemetry data in compressed form, wherein
the encoded message has a variable length to store a change in the telemetry data; and
transmitting the encoded message over the wireless network.

2. A method according to claim 1, wherein the wireless network is a two-way paging system.

3. A method according to claim 1, the method further comprising:
receiving an enable command over the wireless network to enable compression of the telemetry data.

4. A method according to claim 1, wherein the telemetry data includes positional data of the asset.

5. A method according to claim 2, wherein the positional data includes Global Positioning System (GPS) data.

6. A method according to claim 1, the method further comprising:
determining whether the telemetry data is valid; and
encoding an invalid telemetry data differently from a valid telemetry data.

7. A method according to claim 1, the method further comprising:
establishing a reference point for the telemetry data, wherein the change is based on the reference point.

8. A method according to claim 1, wherein the encoded message includes a plurality of bit segments, the most significant bit of each bit segment indicating whether subsequent bit segments exist.

9. A method according to claim 1, wherein the most significant bit of the encoded message represents a sign bit.

10. A method for tracking an asset over a wireless network, the method comprising:
transmitting a command to instruct a telemetry device over the wireless network to compress telemetry data associated with the asset, wherein the telemetry device, in response to the command, generates an encoded message to represent the telemetry data in compressed form, wherein the encoded message has a variable length to store a change in the telemetry data; and
receiving the encoded message over the wireless network.

11. A method according to claim 10, wherein the wireless network is a two-way paging system.

12. A method according to claim 10, the method further comprising:
transmitting a disable command to the telemetry device over the wireless network to disable compression of subsequent telemetry data.

13. A method according to claim 10, wherein the telemetry data includes positional data of the asset.

14. A method according to claim 13, wherein the positional data includes Global Positioning System (GPS) data.

15. A method according to claim 10, the telemetry device is configured to determine whether the telemetry data is valid, and to encode an invalid telemetry data differently from a valid telemetry data.

16. A method according to claim 10, wherein a reference point is established for the telemetry data, the change being based on the reference point.

17. A method according to claim 10, wherein the encoded message includes a plurality of bit segments, the most significant bit of each bit segment indicating whether subsequent bit segments exist.

18. A method according to claim 10, wherein the most significant bit of the encoded message represents a sign bit.

19. An apparatus for tracking an asset over a wireless network, the apparatus comprising:
compression logic configured to generate an encoded message to represent telemetry data associated with the asset in compressed form, wherein the encoded message has a variable length to store a change in the telemetry data; and
a transceiver configured to transmit the encoded message over the wireless network.

20. An apparatus according to claim 19, wherein the wireless network is a two-way paging system.

21. An apparatus according to claim 19, wherein the transceiver receives an enable command over the wireless network to enable compression of the telemetry data.

22. An apparatus according to claim 19, wherein the telemetry data includes positional data of the asset.

23. An apparatus according to claim 22, wherein the positional data includes Global Positioning System (GPS) data.

24. An apparatus according to claim 19, the apparatus further comprising:
means for determining whether the telemetry data is valid,
wherein the compression logic encodes an invalid telemetry data differently from a valid telemetry data.

25. An apparatus according to claim 19, wherein a reference point is established for the telemetry data, and the change is based on the reference point.

26. An apparatus according to claim 19, wherein the encoded message includes a plurality of bit segments, the most significant bit of each bit segment indicating whether subsequent bit segments exist.

27. An apparatus according to claim 19, wherein the most significant bit of the encoded message represents a sign bit.
